(19) United States
(12) Patent Application Publication
(10) Pub. No.: US 2023/0007555 A1
(43) Pub. Date: Jan. 5, 2023

(54) SEARCH SPACE SET GROUP SWITCHING METHOD AND DEVICE

(71) Applicant: VIVO MOBILE COMMUNICATION CO., LTD., Dongguan (CN)

(72) Inventors: Dajie JIANG, Dongguan (CN); Xueming PAN, Dongguan (CN); Xiaodong SHEN, Dongguan (CN); Kai WU, Dongguan (CN); Dongru LI, Dongguan (CN)

(73) Assignee: VIVO MOBILE COMMUNICATION CO., LTD., Dongguan (CN)

(21) Appl. No.: 17/939,917

(22) Filed: Sep. 7, 2022

Related U.S. Application Data
(63) Continuation of application No. PCT/CN2021/078585, filed on Mar. 2, 2021.

(30) Foreign Application Priority Data
Mar. 9, 2020 (CN) 202010158045.7

(51) Int. Cl. H04W 36/08; H04W 72/04

(52) U.S. Cl. CPC H04W 36/08; H04W 72/042

(57) ABSTRACT

A search space set group switching method and a device are provided. The method includes: receiving configuration information of at least two search space set groups; and switching to a first search space set group if the terminal executes a target behavior. The first search space set group is any one of the at least two search space set groups, and each of the at least two search space set groups includes at least one search space set.

### CROSS-REFERENCE TO RELATED APPLICATIONS

This application is a continuation of International Application No. PCT/CN2021/078585, filed on Mar. 2, 2021, which claims priority to Chinese Patent Application No. 202010158045.7, filed on Mar. 9, 2020. The entire contents of each of the above-referenced applications are expressly incorporated herein by reference.

### TECHNICAL FIELD

Embodiments of the present disclosure relate to the field of communications technologies, and in particular, to a search space set group switching method and a device.

### BACKGROUND

In a New Radio (NR) system, parameters such as a Physical Downlink Control Channel (PDCCH) monitoring period (for example, monitoring slot period), an offset, and a monitoring time length (for example, duration) can be configured for each PDCCH search space. In addition, PDCCH search spaces are classified into a common search space and a UE-specific search space, and different Radio Network Temporary Identities (RNTI) may be separately used for scrambling.

Different PDCCH search space sets may be flexibly configured for different scenarios. In an existing protocol, a scheme of configuring two search space set groups through Radio Resource Control (RRC) and activating one of the search space set groups through Downlink Control Information (DCI) is proposed.

Because a search space set group is currently activated by using DCI, a terminal needs to detect whether the DCI is received, which is not conducive to power saving of the terminal.

### SUMMARY

An objective of embodiments of the present disclosure is to provide a search space set group switching method and a device.

According to a first aspect, an embodiment of the present disclosure provides a search space set group switching method, applied to a terminal and including:

receiving configuration information of at least two search space set groups; and

switching to a first search space set group if the terminal executes a target behavior, where

the first search space set group is any one of the at least two search space set groups, and each of the at least two search space set groups includes at least one search space set.

According to a second aspect, an embodiment of the present disclosure provides a search space set group switching method, applied to a network device and including:

sending configuration information of at least two search space set groups to a terminal, where

the at least two search space set groups include a first search space set group, the first search space set group is a search space set group to which the terminal switches after the terminal executes a target behavior, and each of the at least two search space set groups includes at least one search space set.

According to a third aspect, an embodiment of the present disclosure provides a terminal, including:

a receiving module, configured to receive configuration information of at least two search space set groups; and

a switching module, configured to switch to a first search space set group if the terminal executes a target behavior, where

the first search space set group is any one of the at least two search space set groups, and each of the at least two search space set groups includes at least one search space set.

According to a fourth aspect, an embodiment of the present disclosure provides a network device, including:
a second sending module, configured to send configuration information of at least two search space set groups to a terminal, where
the at least two search space set groups include a first search space set group, the first search space set group is a search space set group to which the terminal switches after the terminal executes a target behavior, and each of the at least two search space set groups includes at least one search space set.

According to a fifth aspect, an embodiment of the present disclosure provides a communications device, including a processor, a memory, and a program that is stored in the memory and that can be run on the processor, where when the program is executed by the processor, the steps of the search space set group switching method in the first aspect or the second aspect are implemented.

According to a sixth aspect, an embodiment of the present disclosure provides a computer-readable storage medium, where the computer-readable storage medium stores a computer program, and when the computer program is executed by a processor, the steps of the search space set group switching method in the first aspect or the second aspect are implemented.

According to a seventh aspect, an embodiment of the present disclosure further provides a computer software product, where the computer software product is stored in a non-volatile storage medium, and the software product is configured to be executed by at least one processor to implement the steps of the search space set group switching method in the first aspect or the second aspect.

In the embodiments of the present disclosure, after a terminal executes a target behavior, even if the terminal does not receive signaling instructing to activate a search space set group, the terminal may automatically switch to a target search space set group, thereby reducing power consumption of receiving signaling by the terminal and helping the terminal save power and signaling resources.

### BRIEF DESCRIPTION OF DRAWINGS

Accompanying drawings are merely used for showing the exemplary implementation manners, but not considered as a limitation on the present disclosure. In all accompanying drawings, a same reference symbol is used to indicate a same part. In the accompanying drawings:

FIG. 1 is a schematic architectural diagram of a communications system according to an embodiment of the present disclosure;

FIG. 2 is a first schematic diagram of a search space set group switching method according to an embodiment of the present disclosure;

FIG. 3 is a second schematic diagram of a search space set group switching method according to an embodiment of the present disclosure;

FIG. 4 is a schematic diagram of a terminal according to an embodiment of the present disclosure;

FIG. 5 is a schematic diagram of a network device according to an embodiment of the present disclosure; and

FIG. 6 is a schematic diagram of a communications device according to an embodiment of the present disclosure.

### DETAILED DESCRIPTION

The following describes the technical solutions in the embodiments of the present disclosure with reference to the accompanying drawings in the embodiments of the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

The term “include” and any other variants in the specification and claims of this application mean to cover the non-exclusive inclusion, for example, a process, method, system, product, or device that includes a list of steps or units is not necessarily limited to those steps or units, but may include other steps or units not expressly listed or inherent to such a process, method, product, or device. In addition, in the specification and claims, “and/or” is used to indicate at least one of connected objects. For example, A and/or B represents the following three cases: Only A is included, only B is included, and both A and B exist.

In the embodiments of the present disclosure, the word such as “example” or “for example” is used to represent giving an example, an illustration, or a description. Any embodiment or design scheme described as an “example” in the embodiments of the present disclosure should not be explained as being more preferred or having more advantages than another embodiment or design scheme. Exactly, use of the term “example” or “for example” is intended to present a concept in an exemplary manner.

The technology described in this specification is not limited to a Long Term Evolution (LTE)/LTE-Advanced (LTE-A) system, and can also be used in various wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system.

The terms “system” and “network” are often used interchangeably. The CDMA system may implement wireless technologies such as CDMA2000 and Universal Terrestrial Radio Access (UTRA). UTRA includes Wideband CDMA (WCDMA) and other CDMA variants. The TDMA system can implement radio technologies such as Global System for Mobile Communications (GSMs). The OFDMA system can implement radio technologies such as Ultra Mobile Broadband (UMB), Evolution-UTRA (E-UTRA), IEEE 802.11 (Wi-Fi), IEEE 802.16 (WiMAX), IEEE 802.20, and Flash-OFDM. UTRA and E-UTRA are parts of a Universal Mobile Telecommunications System (UMTS). LTE and more advanced LTE (for example, LTE-A) are new UMTS versions using E-UTRA. UTRA, E-U IRA, UMTS, LTE, LTE-A, and GSM are described in the literature from an organization called 3rd Generation Partnership Project (3GPP). CDMA2000 and UMB are described in the literature from an organization called “3rd Generation Partnership Project 2” (3GPP2). The technologies described herein can be used both in the systems and radio technologies mentioned above, and can also be used in other systems and radio technologies.

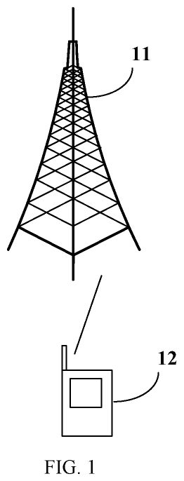

The embodiments of the present disclosure are described below with reference to the accompanying drawings. A search space set group switching method and a device provided in the embodiments of the present disclosure may be applied to a wireless communications system. Referring to FIG. 1, FIG. 1 is a schematic architectural diagram of a communications system according to an embodiment of the present disclosure. As shown in FIG. 1, the wireless communications system may include a network device 11 and a terminal 12. The terminal 12 may be denoted as UE 12, and the terminal 12 may communicate (transmit signaling or transmit data) with the network device 11. In actual application, a connection between the devices may be a wireless connection. For ease of visually indicating a connection relationship between the devices, solid lines are used for illustration in FIG. 1.

The network device 11 provided in the embodiments of the present disclosure may be a base station, and the base station may be a commonly used base station, or may be an evolved node base station (eNB), or may be a network device in a 5G system (for example, a next generation node base station (gNB) or a Transmission and Reception Point (TRP)).

The terminal 12 provided in the embodiments of the present disclosure may be a mobile phone, a tablet computer, a notebook computer, an Ultra-Mobile Personal Computer (UMPC), a netbook, a Personal Digital Assistant (PDA), a Mobile Internet Device (MID), a wearable device, an in-vehicle device, or the like.

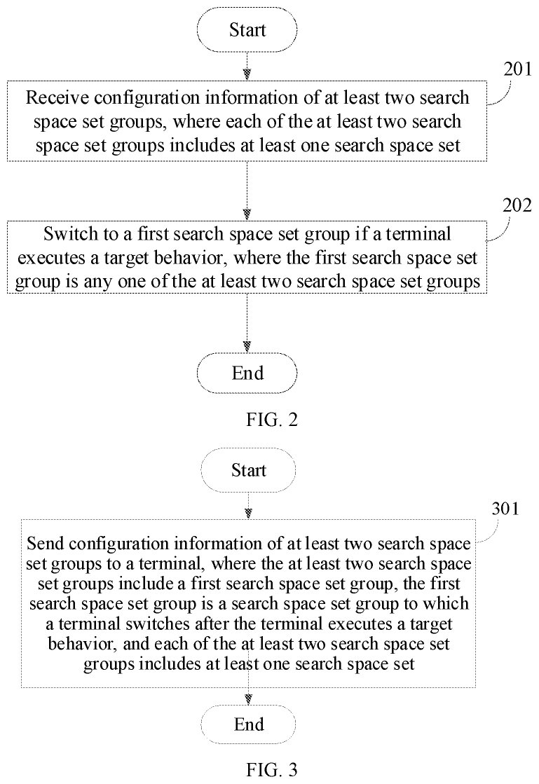

Referring to FIG. 2, an embodiment of the present disclosure provides a search space set group switching method. The method may be executed by a terminal and includes step 201 and step 202.

Step 201: Receive configuration information of at least two search space set groups, where each of the at least two search space set groups includes at least one search space set.

For example, two search space set groups are configured, that is, a search space set group 1 and a search space set group 2, where the search space set group 1 or the search space set group 2 is a first search space set group (or referred to as a target search space set group).

For another example, three search space set groups are configured, that is, a search space set group 1, a search space set group 2, and a search space set group 3, where the search space set group 1, the search space set group 2, or the search space set group 3 is a first search space set group.

In some embodiments, the at least two search space set groups may correspond to a same BandWidth Part (BWP) or different BWPs, that is, the at least two search space set groups may be at least two search space set groups in a same BWP, or may be at least two search space set groups in different BWPs.

In some embodiments, any one of the at least two Search space set groups is configured with one or more of the following:

(1) fallback DCI, for example, a DCI format 0_0 or a DCI format 1_0; and

(2) non-fallback DCI, for example, a DCI format 0_1 or a DCI format 1_1.

That is, one search space set group is configured with only fallback DCI, or one search space set group is configured with non-fallback DCI, or one search space set group is configured with fallback DCI and/or non-fallback DCI.

In some embodiments, any one of the at least two Search space set groups is configured with one or more of the following:

(1) an uplink grant (UL grant), for example, a DCI format 0_0 or a DCI format 1_0; and

(2) a downlink grant (DL grant), for example, a DCI format 0_1 or a DCI format 1_1.

That is, one search space set group is configured with only an UL grant, or one search space set group is configured with a DL grant, or one search space set group is configured with an UL grant and/or a DL grant.

In some embodiments, a parameter of the search space set includes a valid time of the search space set, and the valid time is used to indicate whether the search space set is invalid. For example, the valid time is N milliseconds (ms) or N slots, and N is a positive integer greater than or equal to 1.

If the valid time of the search space set expires, the search space set is invalid. If the valid time of the search space set does not expire, the search space set is valid.

It can be understood that the parameter of the search space set may further include an existing parameter specified in an existing protocol.

Further, the valid time of the search space set may be configured by using higher layer signaling (for example, RRC signaling).

Step 202: Switch to a first search space set group if the terminal executes a target behavior, where the first search space set group is any one of the at least two search space set groups.

The target behavior is used to trigger the terminal to automatically switch to the first search space set group, and the first search space set group may also be referred to as a target search space set group.

The switching to a first search space set group means that UE monitors a PDCCH according to a search space set configuration of the first search space set group, that is, the UE switches to the first search space set group to monitor the PDCCH. That is, the terminal no longer monitors the PDCCH according to a previous search space set configuration.

For example, before switching to the first search space set group, the terminal monitors a physical downlink control channel according to a second search space set group, where the second search space set group is a search space set group other than the first search space set group in the at least two search space set groups. If the terminal executes the target behavior, the terminal no longer monitors the PDCCH according to the second search space set group.

In some embodiments, the target behavior may be configured by a network side. For example, the terminal receives configuration information of the target behavior from a network device. For example, the terminal receives higher layer signaling (for example, RRC signaling) from the network device, and the higher layer signaling carries the configuration information of the target behavior of the terminal.

In some embodiments, the target behavior includes one or more of the following:

(1) Sending uplink data scheduled by a configured grant.

For example, uplink data scheduled by a type 1 and/or type 2 configured grant is sent.

For example, the terminal automatically switches to the first search space set group when sending the uplink data scheduled by the type 1 and/or type 2 configured grant (for example, the uplink data is transmitted by using a Physical Uplink Shared Channel (PUSCH)). For example, if a PDCCH monitoring period of the first Search space set group is smaller, uplink data can be rapidly transmitted while saving signaling resources.

(2) Sending a Scheduling Request (SR).

(3) Sending a Negative Acknowledgement (NACK) corresponding to data (for example, data transmitted by using a Physical Downlink Shared Channel (PDSCH)) of Semi-Persistent Scheduling (SPS).

(4) Failing to receive the data of the downlink semi-persistent scheduling (for example, a PDSCH).

That is, after sending the NACK corresponding to the data of the downlink SPS, or failing to receive the data of the downlink SPS scheduling, the terminal automatically switches to the first Search space set group, so that scheduling of retransmitted data can be quickly received while saving signaling.

(5) Sending a beam failure recovery request.

(6) Receiving a response of the beam failure recovery request.

(7) Sending a random access message.

For example, a 4-step random access message 1 (MSG 1) is sent, a 4-step random access message 3 (MSG 3) is sent, and/or a 2-step random access message A (MSG A) is sent.

(8) Receiving a random access message.

For example, a 4-step random access message 4 (MSG 4) is received, and/or a 2-step random access message B (MSG B) is received.

In some implementations, step 202 may include:

switching to the first search space set group of a second cell if the terminal executes the target behavior in a first cell, where the first cell and the second cell are a same serving cell of the terminal, or the first cell and the second cell are different serving cells of the terminal.

In some implementations, the terminal switches to the first search space set group of the second cell after an application delay if the terminal executes the target behavior in the first cell.

In some implementations, any one of the following is executed if a bandwidth part is switched during an application delay:

(1) switching to a corresponding search space set group on a target bandwidth part; and

(2) switching to the first search space set group of a primary cell or a secondary cell of the terminal.

In some implementations, the terminal does not expect switching of a bandwidth part during the application delay.

In this embodiment of the present disclosure, the application delay is obtained through one or more of the following:

(1) Being stipulated in a protocol.

(2) Being configured by a network side.

For example, the network side configures the application delay by using higher layer signaling (RRC signaling).

(3) Being determined based on the first cell.

That is, application delays corresponding to different first cells (for example, a primary cell or a secondary cell of the terminal) are also different.

(4) Being determined based on the second cell.

That is, application delays corresponding to different second cells (for example, a primary cell or a secondary cell of the terminal) are different.

(5) Being determined by the terminal.

For example, the application delay may be M ms, M slots, or M symbols, and M may be a natural number.

In this embodiment of the present disclosure, the method shown in FIG. 2 may further include:

reporting a terminal capability of the terminal to a network side, where the terminal capability includes the application delay.

That is, the terminal reports the terminal capability, so that the network side learns that the terminal has an application delay capability. In this way, it can be ensured that a time for the terminal to be switched to the first search space set group is consistent between the terminal and the network side.

In this embodiment of the present disclosure, the first cell and the second cell include any one of the following:

(1) the first cell is a primary cell of the terminal, and the second cell is the primary cell;

(2) the first cell is a secondary cell of the terminal, and the second cell is the secondary cell;

(3) the first cell is a primary cell or a secondary cell of the terminal, and the second cell is the primary cell;

(4) the first cell is a primary cell or a secondary cell of the terminal, and the second cell is the secondary cell;

(5) the first cell is one cell in a discontinuous reception group, and the second cell is all cells in the discontinuous reception group, where discontinuous reception parameters of all the cells in the discontinuous reception group are the same;

(6) the first cell is one secondary cell of the terminal, and the second cell is all secondary cells of the terminal; and

(7) the first cell is a primary cell of the terminal, and the second cell is all serving cells of the terminal or a primary cell group in which the primary cell of the terminal is located.

In some embodiments, the first cell and the second cell in (1) to (7) may be configured by the network side by using higher layer signaling (for example, RRC signaling).

In this embodiment of the present disclosure, after a terminal executes a target behavior, even if the terminal does not receive signaling instructing to activate a search space set group, the terminal may automatically switch to a target search space set group, thereby reducing power consumption of receiving signaling by the terminal and helping the terminal save power and signaling resources.

Referring to FIG. 3, an embodiment of the present disclosure further provides a search space set group switching method. The method may be executed by a network device and includes step 301.

Step 301: Send configuration information of at least two search space set groups to a terminal.

The at least two search space set groups include a first search space set group, the first search space set group is a search space set group to which the terminal switches after the terminal executes a target behavior, and each of the at least two search space set groups includes at least one search space set.

In some implementations, the network device may send configuration information of the target behavior of the terminal to the terminal. That is, the network device may carry the configuration information of the target behavior of the terminal by using higher layer signaling (for example, RRC signaling).

In some implementations, the method further includes: switching to the first search space set group if it is detected that the terminal executes the target behavior. That is, if the network device detects that the terminal executes the target behavior, the terminal switches to the first search space set group to send a PDCCH.

In some embodiments, the target behavior includes one or more of the following:

(1) Sending uplink data scheduled by a configured grant.

For example, uplink data scheduled by a type 1 and/or type 2 configured grant is sent.

(2) Sending a scheduling request.

(3) Sending a NACK corresponding to data of downlink SPS.

(4) Failing to receive the data of the downlink SPS scheduling.

(5) Sending a beam failure recovery request.

(6) Receiving a response of the beam failure recovery request.

(7) Sending a random access message.

For example, a 4-step random access MSG 1 is sent, a 4-step random access MSG 3 is sent, and/or a 2-step random access MSG A is sent.

(8) Receiving a random access message.

For example, a 4-step random access MSG 4 is received, and/or a 2-step random access MSG B is received.

In this embodiment of the present disclosure, after a terminal executes a target behavior, even if the terminal does not receive signaling instructing to activate a search space set group, the terminal may automatically switch to a target search space set group, thereby reducing power consumption of receiving signaling by the terminal and helping the terminal save power and signaling resources.

The following describes the method with reference to an implementation 1 of the present disclosure, an implementation 2 of the present disclosure, an implementation 3 of the present disclosure, and an implementation 4 of the present disclosure.

Implementation 1 of the Present Disclosure

UE automatically switches to a first Search space set group (hereinafter referred to as a target search space set group) after the UE sends uplink data scheduled by a configured grant.

The sending uplink data scheduled by a configured grant includes sending uplink data scheduled by a type 1 and/or type 2 configured grant. The sending uplink data scheduled by a configured grant may be understood as a target behavior of the UE, that is, after the UE executes the target behavior, the UE automatically switches to the target search space set group.

The switching to the target search space set group means that the UE monitors a PDCCH according to a search space set configuration of the target search space set group.

In some embodiments, the target behavior and the target search space set group may be configured by a network, for example, a network side configures the target behavior and the target search space set group by using higher layer signaling (for example, RRC).

In some implementations, after the UE sends the uplink data scheduled by the configured grant, the UE automatically switches to the target search space set group after an application delay. The application delay may be defined in a protocol or configured by the network side.

Exemplary scenarios of the implementation 1 of the present disclosure may include the following several scenarios:

(1) After UE sends, in a Primary Cell (PCell), uplink data scheduled by a configured grant, the UE automatically switches to a target search space set group of the PCell.

(2) After UE sends, in a preset Secondary Cell (SCell), uplink data scheduled by a configured grant, the UE automatically switches to a target search space set group of the SCell.

(3) After UE sends, in a PCell or a preset SCell, uplink data scheduled by a configured grant, the UE automatically switches to a target search space set group of the PCell.

(4) After UE sends, in a PCell or a preset SCell, uplink data scheduled by a configured grant, the UE automatically switches to a target search space set group of the preset SCell.

It can be understood that the preset SCell may be any SCell of the UE.

The PCell and the preset SCell may be configured by a network side by using higher layer signaling (for example, RRC signaling).

Further, values of application delays for automatically switching to different target search space set groups of the PCell and the preset SCell may be the same or may be different.

In this implementation, the UE automatically switches to the target search space set group after the UE sends the uplink data scheduled by the configured grant, so that signaling for the network side to indicate switching of the UE can be saved. Further, a PDCCH monitoring period of the target search space set group is denser than a PDCCH monitoring period of another search space set group, so that uplink data can be rapidly transmitted while saving signaling.

Implementation 2 of the Present Disclosure

after UE sends a NACK corresponding to data of downlink SPS or when UE fails to receive data of downlink SPS scheduling, the UE automatically switches to a target search space set group.

The switching to a target search space set group means that the UE monitors a PDCCH according to a search space set configuration of the target search space set group.

It can be understood that after switching to the target search space set group, the UE no longer monitors the PDCCH according to a previous search space set configuration.

That the UE sends the NACK corresponding to the data of the downlink SPS scheduling or the UE fails to receive the data of the downlink SPS scheduling may be understood as a target behavior of the UE, that is, the UE automatically switches to the target search space set group after the UE executes the target behavior.

In some embodiments, the target behavior and the target search space set group may be configured by a network, for example, a network side configures the target behavior and the target search space set group of the UE by using higher layer signaling (for example, RRC).

In some implementations, the UE automatically switches to the target search space set group after an application delay after the UE sends the NACK corresponding to the data of the downlink SPS scheduling or when the UE fails to receive the data of the downlink SPS scheduling.

The application delay may be defined in a protocol, or may be configured by the network side, for example, configured by using higher layer signaling (for example, RRC signaling).

Exemplary scenarios of the implementation 2 of the present disclosure may include the following several scenarios:

(1) After UE sends a NACK corresponding to data of downlink SPS scheduling of a PCell, the UE automatically switches to a target search space set group of the PCell.

(2) After UE sends a NACK corresponding to data of downlink SPS scheduling of a SCell, the UE automatically switches to a target search space set group of the SCell.

(3) After UE sends a NACK corresponding to data of downlink SPS scheduling of a PCell or a preset SCell, the UE automatically switches to a target search space set group of the PCell.

(4) After UE sends a NACK corresponding to data of downlink SPS scheduling of a PCell or a preset SCell, the UE automatically switches to a target search space set group of the preset SCell.

It can be understood that the preset SCell may be any SCell of the UE.

The PCell and the preset SCell may be configured by a network side by using higher layer signaling (for example, RRC signaling).

Further, values of application delays for switching to different target search space set groups of the PCell and the preset SCell may be the same or may be different.

In this implementation, the UE automatically switches to the target search space set group after the UE sends the NACK corresponding to the data of the downlink SPS scheduling or when the UE fails to receive the data of the downlink SPS scheduling, so that signaling for the network side to indicate switching of the UE can be saved. Further, a PDCCH monitoring period of the target search space set group is denser than a PDCCH monitoring period of another search space set group, so that scheduling of retransmitted data can be rapidly received while saving signaling.

Implementation 3 of the Present Disclosure

After UE sends a beam failure recovery request or after UE receives a response that is sent by a base station and that is corresponding to a beam failure recovery request, the UE automatically switches to a target search space set group.

The switching to a target search space set group means that the UE monitors a PDCCH according to a search space set configuration of the target search space set group.

It can be understood that after switching to the target search space set group, the UE no longer monitors the PDCCH according to a previous search space set configuration.

That the UE sends the beam failure recovery request or the UE receives the response that is sent by the base station and that is corresponding to the beam failure recovery request may be understood as a target behavior of the UE, that is, the UE automatically switches to the target search space set group after the UE executes the target behavior.

In some embodiments, the target behavior and the target search space set group may be configured by a network, for example, a network side configures the target behavior and the target search space set group of the UE by using higher layer signaling (for example, RRC).

In some implementations, after UE sends the beam failure recovery request or after the UE receives the response that is sent by the base station and that is corresponding to the beam failure recovery request, the UE automatically switches to the target search space set group after an application delay.

The application delay may be defined in a protocol, or may be configured by the network side, for example, configured by using higher layer signaling (for example, RRC signaling).

Exemplary scenarios of the implementation 3 of the present disclosure may include the following several scenarios:

(1) After UE sends a beam failure recovery request to a PCell or after UE receives a response that is sent by a PCell and that is corresponding to a beam failure recovery request, the UE automatically switches to a target search space set group of the PCell.

(2) After UE sends a beam failure recovery request to a PCell or after UE receives a response that is sent by a PCell and that is corresponding to a beam failure recovery request, the UE automatically switches to a target search space set group of a preset SCell.

Further, values of application delays for switching to different target search space set groups of the PCell and the preset SCell may be the same or may be different.

In this implementation, after UE sends the beam failure recovery request or after the UE receives the response that is sent by the base station and that is corresponding to the beam failure recovery request, the UE automatically switches to the target search space set group, so that signaling for the network side to indicate switching of the UE can be saved.

Implementation 4 of the Present Disclosure

After UE sends a random access message (RACH message) or receives a random access message, the UE automatically switches to a target search space set group.

It can be understood that the random access message may be a random access message in a 4-step random access process, or may be a random access message in a 2-step random access process.

4-Step Random Access Process

(1) After the UE sends a message 1 (MSG 1) or a message 3 (MSG 3), the UE automatically switches to the target search space set group.

(2) After the UE receives a message 4 (MSG 4), the UE automatically switches to the target search space set group.

That the UE sends the MSG 1 or the MSG 3 or the UE receives the MSG 4 may be understood as a target behavior of the UE, that is, the UE automatically switches to the target search space set group after the UE executes the target behavior.

In some embodiments, the target behavior and the target search space set group may be configured by a network, for example, a network side configures the target behavior and the target search space set group of the UE by using higher layer signaling (for example, RRC).

2-Step Random Access Process

(1) After the UE sends a message A (MSG A), the UE automatically switches to the target search space set group.

(2) After the UE receives a message B (MSG B), the UE automatically switches to the target search space set group.

That the UE sends the MSG A or the UE receives the MSG B may be understood as a target behavior of the UE, that is, the UE automatically switches to the target search space set group after the UE executes the target behavior.

In some embodiments, the target behavior and the target search space set group may be configured by a network, for example, a network side configures the target behavior and the target search space set group of the UE by using higher layer signaling (for example, RRC).

The switching to a target search space set group means that the UE monitors a PDCCH according to a search space set configuration of the target search space set group.

It can be understood that after switching to the target search space set group, the UE no longer monitors the PDCCH according to a previous search space set configuration.

In some embodiments, the target search space set group includes a target search space set group of a PCell or a target search space set group of a SCell.

In some embodiments, after the UE executes the target behavior, the UE automatically switches to the target search space set group after an application delay.

The application delay may be defined in a protocol, or may be configured by the network side, for example, configured by using higher layer signaling (for example, RRC signaling).

In some embodiments, 2-step random access and 4-step random access may be Contention Based Random Access (CBRA) or Contention Free Random Access (CFRA).

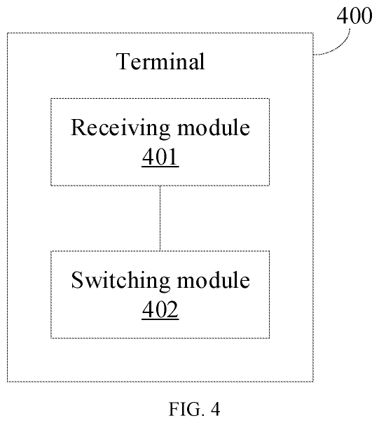

Referring to FIG. 4, an embodiment of the present disclosure further provides a terminal, and the terminal 400 includes:

a receiving module 401, configured to receive configuration information of at least two search space set groups; and

a switching module 402, configured to switch to a first search space set group if the terminal executes a target behavior, where

the first search space set group is any one of the at least two search space set groups, and each of the at least two search space set groups includes at least one search space set.

In some implementations, the target behavior includes one or more of the following:

(1) Sending uplink data scheduled by a configured grant.

For example, uplink data scheduled by a type 1 and/or type 2 configured grant is sent.

(2) Sending a scheduling request.

(3) Sending a NACK corresponding to data of downlink SPS.

(4) Failing to receive the data of the downlink SPS scheduling.

(5) Sending a beam failure recovery request.

(6) Receiving a response of the beam failure recovery request.

(7) Sending a random access message.

(8) Receiving a random access message.

In some implementations, the switching module 402 is further configured to switch to the first search space set group of a second cell if the terminal executes the target behavior in a first cell, where

the first cell and the second cell are a same serving cell of the terminal, or the first cell and the second cell are different serving cells of the terminal.

In some implementations, the switching module 402 is further configured to switch to the first search space set group of the second cell after an application delay if the terminal executes the target behavior in the first cell.

In some implementations, the switching module 402 is further configured to execute any one of the following if a bandwidth part is switched during the application delay:

switching to a corresponding search space set group on a target bandwidth part; and

switching to the first search space set group of a primary cell or a secondary cell of the terminal.

In some implementations, the terminal does not expect switching of a bandwidth part during the application delay.

In this embodiment of the present disclosure, the application delay is obtained through one or more of the following: (1) being stipulated in a protocol; (2) being configured by a network side; (3) being determined based on the first cell; (4) being determined based on the second cell; and (5) being determined by the terminal.

In some implementations, the terminal 400 further includes:

a first sending module, configured to report a terminal capability of the terminal to a network side, where the terminal capability includes the application delay.

In this embodiment of the present disclosure, the first cell and the second cell include any one of the following:

(1) the first cell is a primary cell of the terminal, and the second cell is the primary cell;

(2) the first cell is a secondary cell of the terminal, and the second cell is the secondary cell;

(3) the first cell is a primary cell or a secondary cell of the terminal, and the second cell is the primary cell;

(4) the first cell is a primary cell or a secondary cell of the terminal, and the second cell is the secondary cell;

(5) the first cell is one cell in a discontinuous reception group, and the second cell is all cells in the discontinuous reception group, where discontinuous reception parameters of all the cells in the discontinuous reception group are the same;

(6) the first cell is one secondary cell of the terminal, and the second cell is all secondary cells of the terminal; and

(7) the first cell is a primary cell of the terminal, and the second cell is all serving cells of the terminal or a primary cell group in which the primary cell of the terminal is located.

In some embodiments, the at least two search space set groups correspond to a same bandwidth part or different bandwidth parts.

In some embodiments, a parameter of a search space set in at least one of the at least two search space set groups includes a valid time of the search space set, and the valid time is used to indicate whether the search space set is invalid.

In some implementations, the terminal 400 further includes:

a monitoring module, configured to monitor a physical downlink control channel according to a second search space set group, where the second search space set group is a search space set group other than the first search space set group in the at least two search space set groups.

In some implementations, the switching to a first search space set group includes: monitoring a physical downlink control channel by using the first search space set group.

In some implementation, the receiving module 401 is further configured to receive configuration information of the target behavior from a network device.

The terminal provided in this embodiment of the present disclosure may perform the foregoing method embodiment shown in FIG. 2. An implementation principle and a technical effect of the terminal are similar to those of the method embodiment, and details are not described herein again in this embodiment.

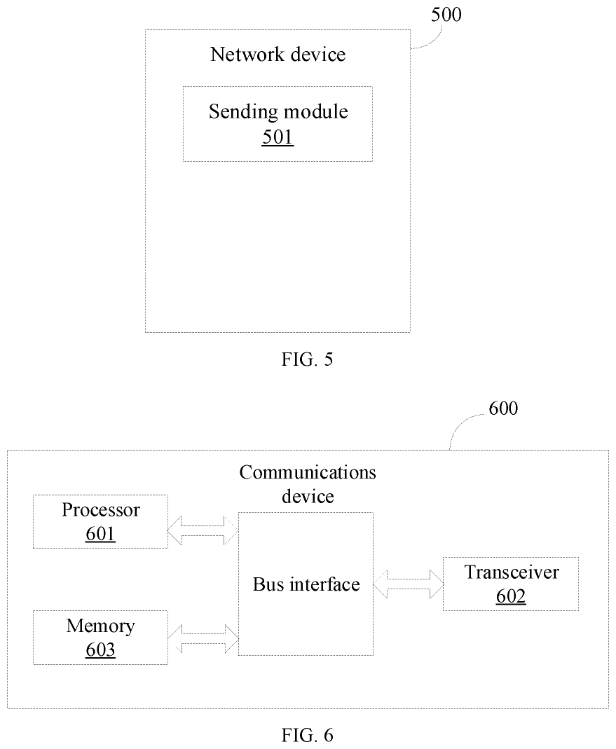

Referring to FIG. 5, an embodiment of the present disclosure further provides a network device, and the network device 500 includes:

a second sending module 501, configured to send configuration information of at least two search space set groups to a terminal, where

the at least two search space set groups include a first search space set group, the first search space set group is a search space set group to which the terminal switches after the terminal executes a target behavior, and each of the at least two search space set groups includes at least one search space set.

In some implementations, the second sending module 501 is further configured to send configuration information of the target behavior to the terminal.

In some implementations, the network device 500 further includes: switching to the first search space set group if it is detected that the terminal executes the target behavior.

In some implementations, the target behavior includes one or more of the following:

(1) Sending uplink data scheduled by a configured grant.

For example, uplink data scheduled by a type 1 and/or type 2 configured grant is sent.

(2) Sending a scheduling request.

(3) Sending a NACK corresponding to data of downlink SPS.

(4) Failing to receive the data of the downlink SPS scheduling.

(5) Sending a beam failure recovery request.

(6) Receiving a response of the beam failure recovery request.

(7) Sending a random access message.

(8) Receiving a random access message.

The network device provided in this embodiment of the present disclosure may perform the foregoing method embodiment shown in FIG. 3. An implementation principle and a technical effect of the network device are similar to those of the method embodiment, and details are not described herein again in this embodiment.

Referring to FIG. 6, FIG. 6 is a structural diagram of a communications device to which the embodiments of the present disclosure are applied. As shown in FIG. 6, a communications device 600 includes a processor 601, a transceiver 602, a memory 603, and a bus interface.

In an embodiment of the present disclosure, the communications device 600 further includes a computer program that is stored in the memory 603 and that can be run on the processor 601, and when the computer program is executed by the processor 601, the steps in the embodiment shown in FIG. 2 or FIG. 3 are implemented.

In FIG. 6, a bus architecture may include any quantity of interconnected buses and bridges. In some embodiments, various circuits of one or more processors represented by the processor 601 and a memory represented by the memory 603 are interconnected. The bus architecture may further link various other circuits such as a peripheral device, a voltage regulator, and a power management circuit. These are well known in the art, and therefore are not further described in this specification. A bus interface provides an interface. The transceiver 602 may be a plurality of components. For example, the transceiver 602 includes a transmitter and a receiver, and provides a unit configured to communicate with various other apparatuses on a transmission medium. It can be understood that the transceiver 602 is an optional component.

The processor 601 is responsible for bus architecture management and general processing. The memory 603 may store data used by the processor 601 when the processor 601 performs an operation.

The communications device provided in this embodiment of the present disclosure may perform the foregoing method embodiment shown in FIG. 2 or FIG. 3. An implementation principle and a technical effect of the communications device are similar to those of the method embodiments, and details are not described herein again in this embodiment.

Method or algorithm steps described in combination with the content disclosed in the present disclosure may be implemented by hardware, or may be implemented by a processor by executing a software instruction. The software instruction may include a corresponding software module. The software module may be stored in a Random Access Memory (RAM), a flash memory, a Read-Only Memory (ROM), an Erasable PROM (EPROM), an Electrically EPROM (EEPROM), a register, a hard disk, a removable hard disk, a compact disc read only memory, or any other form of storage medium well-known in the art. For example, a storage medium is coupled to the processor, so that the processor can read information from the storage medium or write information into the storage medium. The storage medium may be a component of the processor. The processor and the storage medium may be located in an Application Specific Integrated Circuit (ASIC). In addition, the ASIC may be located in a core network interface device. The processor and the storage medium may exist in the core network interface device as discrete components.

It can be understood that the embodiments described in the present disclosure may be implemented by hardware, software, firmware, middleware, microcode, or a combination thereof. For hardware implementation, a module, a unit, a submodule, a subunit, or the like may be implemented in one or more ASIC, Digital Signal Processors (DSPs), DSP Devices (DSPDs), Programmable Logic Devices (PLDs), Field-Programmable Gate Arrays (FPGAs), general purpose processors, controllers, microcontrollers, microprocessors, or other electronic units or a combination thereof used to perform the functions in this application.

A person skilled in the art should be aware that in the foregoing one or more examples, functions described in the present disclosure may be implemented by hardware, software, firmware, or any combination thereof. When implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a general-purpose or dedicated computer.

It should be understood that the foregoing descriptions are merely exemplary embodiments of the present disclosure, but are not intended to limit the protection scope of the present disclosure. Any modification, equivalent replacement, improvement, or the like based on the technical solutions of the present disclosure shall fall within the protection scope of the present disclosure.

A person skilled in the art should understand that the embodiments of the present disclosure may be provided as a method, a system, or a computer program product. Therefore, the embodiments of the present disclosure may use a form of hardware only embodiments, software only embodiments, or embodiments with a combination of software and hardware. Moreover, the embodiments of the present disclosure may use a form of a computer program product that is implemented on one or more computer-usable storage media (including but not limited to a magnetic disk memory, a CD-ROM, an optical memory, and the like) that include computer-usable program code.

The embodiments of the present disclosure are described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Apparently, persons skilled in the art can make various modifications and variations to embodiments of the present disclosure without departing from the spirit and scope of the present disclosure. In this way, the present disclosure is intended to cover these modifications and variations provided that they fall within the scope of protection defined by the following claims and their equivalent technologies.

1. A search space set group switching method, performed by a terminal, comprising:
receiving configuration information of at least two search space set groups; and
switching to a first search space set group if the terminal executes a target behavior, wherein
the first search space set group is any one of the at least two search space set groups, and each of the at least two search space set groups comprises at least one search space set.

2. The search space set group switching method according to claim 1, wherein the target behavior includes one or more of the following:
sending uplink data scheduled by a configured grant, wherein the sending uplink data scheduled by a configured grant comprises: sending uplink data scheduled by a type 1 or type 2 configured grant;
sending a scheduling request;
sending a negative acknowledgement corresponding to data of downlink semi-persistent scheduling;
failing to receive the data of the downlink semi-persistent scheduling;
sending a beam failure recovery request message;
receiving a response message of the beam failure recovery request;
sending a random access message, wherein the sending a random access message comprises at least one of the following: sending a 4-step random access message 1; sending a 4-step random access message 3; or sending a 2-step random access message A; or
receiving a random access message, wherein the receiving a random access message comprises at least one of the following: receiving a 4-step random access message 4; or receiving a 2-step random access message B.

3. The search space set group switching method according to claim 1, wherein the switching to a first search space set group if the terminal executes a target behavior comprises:
switching to the first search space set group of a second cell if the terminal executes the target behavior in a first cell, wherein
the first cell and the second cell are a same serving cell of the terminal, or the first cell and the second cell are different serving cells of the terminal.

4. The search space set group switching method according to claim 3, wherein the switching to the first search space set group of a second cell if the terminal executes a target behavior in a first cell comprises:
switching to the first search space set group of the second cell after an application delay if the terminal executes the target behavior in the first cell.

5. The search space set group switching method according to claim 1, further comprising:
executing any one of the following if a bandwidth part is switched during an application delay:
switching to a corresponding search space set group on a target bandwidth part; or
switching to the first search space set group of a primary cell or a secondary cell of the terminal.

6. The search space set group switching method according to claim 4, wherein
switching of a bandwidth part is not expected during the application delay.

7. The search space set group switching method according to claim 4, wherein the application delay is obtained through one or more of the following:
being stipulated in a protocol;
being configured by a network side;
being determined based on the first cell;
being determined based on the second cell; or
being determined by the terminal.

8. The search space set group switching method according to claim 4, further comprising:
reporting a terminal capability of the terminal to a network side, wherein the terminal capability includes the application delay.

9. The search space set group switching method according to claim 3, wherein
the first cell is a primary cell of the terminal, and the second cell is the primary cell;
or
the first cell is a secondary cell of the terminal, and the second cell is the secondary cell;
or
the first cell is a primary cell or a secondary cell of the terminal, and the second cell is the primary cell;
or
the first cell is a primary cell or a secondary cell of the terminal, and the second cell is the secondary cell;
or
the first cell is one cell in a discontinuous reception group, and the second cell is all cells in the discontinuous reception group, wherein discontinuous reception parameters of all the cells in the discontinuous reception group are the same;
or
the first cell is one secondary cell of the terminal, and the second cell is all secondary cells of the terminal;
or
the first cell is a primary cell of the terminal, and the second cell is all serving cells of the terminal or a primary cell group in which the primary cell of the terminal is located.

10. The search space set group switching method according to claim 3, wherein the first cell and the second cell are configured by a network side by using higher layer signaling.

11. The search space set group switching method according to claim 1, where the at least two search space set groups correspond to a same bandwidth part or different bandwidth parts.

12. The search space set group switching method according to claim 1, where a parameter of the search space set includes a valid time of the search space set, and the valid time is used to indicate whether the search space set is invalid.

13. The search space set group switching method according to claim 1, wherein before the switching to a first search space set group, the method further comprises:
monitoring a physical downlink control channel according to a second search space set group, wherein the second search space set group is a search space set group other than the first search space set group in the at least two search space set groups.

14. The search space set group switching method according to claim 1, wherein the switching to a first search space set group comprises:
monitoring a physical downlink control channel by using the first search space set group.

15. The search space set group switching method according to claim 1, further including:
receiving configuration information of the target behavior from a network device.

16. A search space set group switching method, performed by a network device, comprising:
sending configuration information of at least two search space set groups to a terminal, wherein
the at least two search space set groups comprise a first search space set group, wherein the first search space set group is a search space set group to which the terminal switches after the terminal executes a target behavior, and each of the at least two search space set groups comprises at least one search space set.

17. The search space set group switching method according to claim 16, further comprising:
switching to the first search space set group if it is detected that the terminal executes the target behavior.

18. The search space set group switching method according to claim 17, wherein the target behavior includes one or more of the following:
sending uplink data scheduled by a type 1 or type 2 configured grant;
sending a scheduling request;
sending a negative acknowledgement corresponding to data of downlink semi-persistent scheduling;
failing to receive the data of the downlink semi-persistent scheduling;
sending a beam failure recovery request message;
receiving a response message of the beam failure recovery request;
sending a random access message; or
receiving a random access message.

19. A terminal, comprising: a memory having a computer program stored thereon; and a processor, wherein the computer program, when executed by the processor, causes the processor to perform operations comprising:
receiving configuration information of at least two search space set groups; and
switching to a first search space set group if the terminal executes a target behavior, wherein the first search space set group is one of the at least two search space set groups, and each of the at least two search space set groups comprises at least one search space set.

20. A network device, comprising: a memory having a computer program stored thereon; and a processor, wherein the computer program, when executed by the processor, causes the processor to perform the search space set group switching method of claim 16.
